(19) United States
(12) Patent Application Publication
(10) Pub. No.: US 2026/0259418 A1
(43) Pub. Date: Sep. 3, 2026

(54) OPTICAL SYSTEMS

(71) Applicant: CORNING INCORPORATED, CORNING, NY (US)

(72) Inventors: Erin Katherine Congdon, Canisteo, NY (US); Ronald William Davis, Jr., Corning, NY (US); Jason Thomas Harris, Horseheads, NY (US); Mark Francis Krol, Corning, NY (US); Naveen Prakash, Fishers, IN (US); James Joseph Price, Corning, NY (US); Horst Herbert Anton Schreiber, Livonia, NY (US)

(21) Appl. No.: 19/489,187

(22) PCT Filed: May 31, 2024
(86) PCT No.: PCT/US2024/031957

§ 371 Date: Dec. 1, 2025

Related U.S. Application Data
(63) Continuation-in-part of application No. 18/238,179, filed on Aug. 25, 2023, now Pat. No. 12,202,764.
(60) Provisional application No. 63/470,498, filed on Jun. 2, 2023.
(60) Provisional application No. 63/526,550, filed on Jul. 13, 2023.
(60) Provisional application No. 63/547,056, filed on Nov. 2, 2023.

(51) Int. Cl. G02B 27/01; G02B 1/11; G02B 27/00; G02B 27/42

(52) U.S. Cl. CPC G02B 27/0172; G02B 1/11; G02B 27/4205; G02B 27/0081; G02B 2027/0125; G02B 2027/013

(57) ABSTRACT

Embodiments of an optical system including a substrate, an optical region and an anti-reflection layer at least partially disposed on the optical region are disclosed. In one or more embodiments, the optical region has a optical region dimension that is less than the length and width dimension of the substrate, and the anti-reflection layer comprises a modulus of elasticity that is less than 1.1 times a modulus of elasticity of the substrate. In one or more embodiments, the substrate comprises a thickness in a range from about 0.1 mm to 1 mm, a density in a range from about 3.5 g/cm³ to about 6 g/cm3, and an optical region having a radius from about 15 mm to about 65 mm.

This application claims the benefit of priority of U.S. Provisional Application No. 63/547,056 filed on Nov. 2, 2023, and claims the benefit of priority of U.S. application Ser. No. 18/238,179 filed on Aug. 25, 2023, which claims the benefit of priority of U.S. Provisional Application No. 63/526,550 filed Jul. 13, 2023 and U.S. Provisional Application No. 63/470,498 filed Jun. 2, 2023, each of which are incorporated by reference in their entirety.

### BACKGROUND

The disclosure relates to various embodiments of optical systems including a substrate and anti-reflection layer disposed on at least a portion of the substrate.

Various embodiment of such optical systems deliver optical performance required for head-mounted displays (HMDs) or heads-up displays (HUDs), which are capable of presenting digital, virtual images to a user within the surrounding environment of the user to provide either a virtual reality (VR) experience (if the user is isolated from the surrounding environment), an augmented reality (AR) experience (if a virtual image is presented to the user as an overlay to the real-world environment), or mixed reality (MR) experience (if a user can interact with virtual objects that appear to be integrated into the user's real-word environment). Such embodiments also provide enhanced strength performance required for manufacturing and assembly of the head-mounted displays while minimizing weight and form factor (or size) for improved user comfort and fit during use. Existing solutions do not deliver this combination of desirable features. Accordingly, a need exists for such optical systems.

### SUMMARY

A first aspect of this disclosure pertains to an optical system comprising: a substrate comprising first and second opposing major surfaces, a length dimension, a width dimension and a modulus of elasticity; an optical region having a diameter that is less than at least one of or both the length dimension and the width dimension; and an anti-reflection layer disposed on at least the entirety of the diameter of the optical region, and up to 100% of one or both of the first major surface and the second major surface; wherein the anti-reflection layer comprises a modulus of elasticity that is less than 1.1 times the modulus of elasticity of the substrate, wherein the diameter of the optical region is in a range from about 30 mm to about 65 mm over a FOV up to 80 degrees, and wherein, when measured at the anti-reflection layer, the substrate and anti-reflection layer comprises a glass-side anti-reflection layer mediated total internal reflection (TIR) reflectance of at least 98%, or an air-side reflectance at an incidence angle up to ±60 degrees of less than 5%, in the visible spectrum from about 450 nm to 650 nm.

A second aspect of this disclosure pertains to an optical system comprising: a lightguide comprising first and second opposing major surfaces, a length dimension, a width dimension, a thickness in a range from about 0.1 mm to 1 mm, a density in a range from about 3.5 g/cm³ to about 6 g/cm³, and a modulus of elasticity; an optical region having a diameter that is less than at least one of or both the length dimension and the width dimension; and an anti-reflection layer disposed on at least the entirety of the optical region and up to 100% of one or both of the first major surface and the second major surface; wherein the anti-reflection layer comprises a modulus of elasticity that is less than 1.1 times the modulus of elasticity of the lightguide, and further comprising a first region configured to receive light from an input coupler, a second region configured to transmit light through an output coupler, and an optical path between the first region and the second region, and one or both of an anti-reflection layer mediated total internal reflection (TIR) transmittance of at least 75% through the optical region along the optical path; and a single-sided reflectance of less than 2%, when measured at the anti-reflection layer at an incidence angle up to ±60 degrees, in the visible spectrum from about 450 nm to 650 nm.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic view of an optical system according to an aspect of this disclosure.

FIG. 2 is a front plan view of the optical system shown in FIG. 1.

FIG. 3 is a schematic view of the optical system shown in Figure, illustrating an optical region.

FIG. 4 is a Weibull plot of maximum load (N), or load at fracture, of substrates without an anti-reflection layer (A) and substrates with an anti-reflection layer (B), according to an aspect of the present disclosure.

FIG. 5A is a Weibull plot of maximum stress (MPa), or ultimate stress, of samples of substrates without an anti-refection layer and optical systems including a substrate and anti-reflection layer according to one or more embodiments of this disclosure.

FIG. 5B is a plot of individual values of maximum stress (MPa), or ultimate stress, of the samples described in FIG. 5.

### DETAILED DESCRIPTION

The following detailed description and figures illustrate aspects of the present disclosure in detail. It should be understood that the present inventive technology is not limited to the details or methodology set forth in the detailed description or illustrated in the figures. For example, as will be understood by those of ordinary skill in the art, features and attributes associated with an aspect shown in one of the figures or described in the text relating to an aspect may be applied to another aspect shown in another of the figures or described elsewhere in the text.

Aspects of this disclosure pertain to an optical system that can be used as part of HMDs or HUDs. HMDs may be wearable and may be provided in the form of eyeglasses, goggles or a helmet worn by a user. HUDs are disposed in various vehicles (e.g., automobiles, aircraft, seacraft, etc.) to project an image that is visible to the driver or other passengers. Various embodiments of the optical system are configured to allow for viewing an object or a scene (which may be a real-world environment or a virtual environment) while also adding an augmenting object to the actual object or to the scene being viewed directly. Accordingly, such optical systems should exhibit the optical properties required for such performance, while also exhibiting the strength required for mass production and assembly into an HMD or HUD. In the case of use in an HMD, the optical systems should also exhibit minimized weight and form factor to provide an HMD that can be worn comfortably and approaches the appearance of eyeglasses. Similar lightweighting and form factor considerations are also useful in HUDs, where increased vehicle energy efficiency and reduced component footprint are highly valued.

In one or more embodiments, the optical systems described herein can be used in a VR HMD or HUD, AR HMD or HUD or MR HMD or HUD. In one or more embodiments, the optical system comprises or is a part of a lightguide exit pupil expander (EPE) system, a reflective combiner system or camera-based projector system. In the case of HUDs, the optical system comprises or part of a dashboard or instrument panel and/or window or windshield.

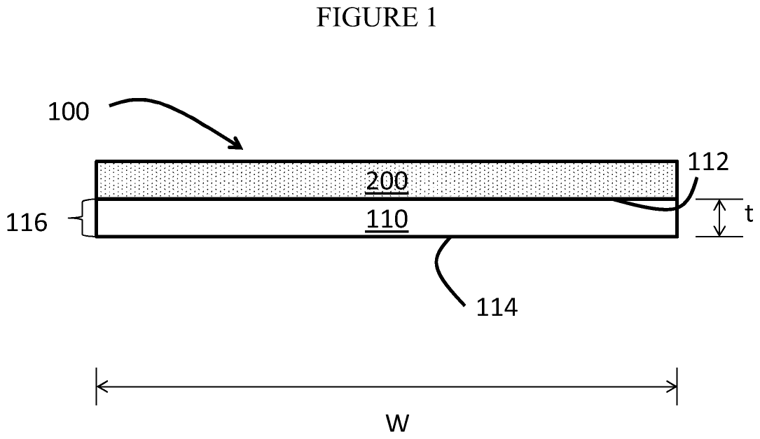

As shown in FIG. 1, in one or more embodiments, the optical system 100 includes a substrate 110 with a first major surface 112 and second major surfaces 114 opposing the first major surface, and an anti-reflection layer 200 disposed on at least a portion of one or both of the first or second major surface.

The term “layer” may include a single layer or may include one or more sub-layers. Such sub-layers may be in direct contact with one another. The sub-layers may be formed from the same material or two or more different materials. In one or more alternative embodiments, such sub-layers may have intervening layers of different materials disposed therebetween. In one or more embodiments a layer may include one or more contiguous and uninterrupted layers and/or one or more discontinuous and interrupted layers (i.e., a layer having different materials formed adjacent to one another). A layer or sub-layers may be formed by any known method in the art, including discrete deposition or continuous deposition processes. In one or more embodiments, the layer may be formed using only continuous deposition processes, or, alternatively, only discrete deposition processes.

As used herein, the term “dispose” includes coating, depositing and/or forming a material onto a surface using any known method in the art. The disposed material may constitute a layer, as defined herein. The phrase “disposed on” includes the instance of forming a material onto a surface such that the material is in direct contact with the surface and also includes the instance where the material is formed on a surface, with one or more intervening material(s) is between the disposed material and the surface. The intervening material(s) may constitute a layer, as defined herein.

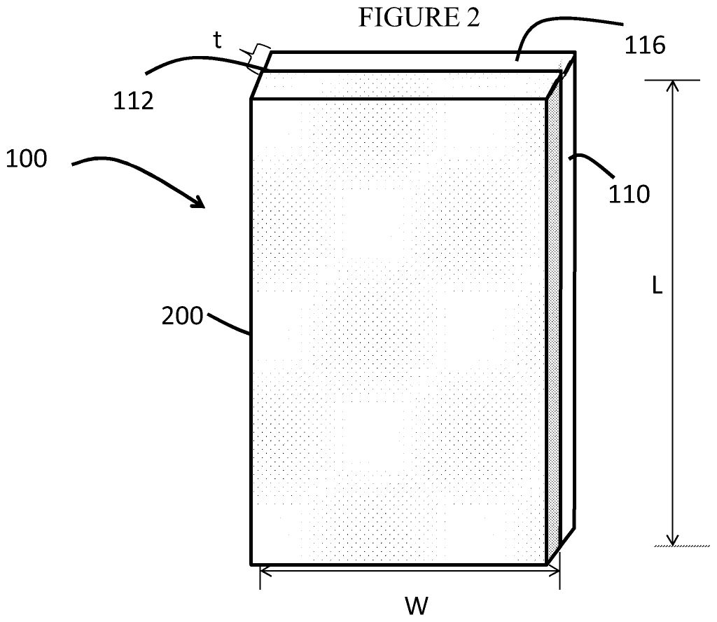

The substrate 110 includes opposing minor surfaces 116 between the first and second opposing major surfaces. In one or more embodiments, the substrate 110 has a thickness (t) that is substantially constant and is defined as a distance between the first major surface 112 and the second major surface 114. The thickness (t) as used herein refers to the maximum thickness of the substrate. In the embodiment shown in FIG. 2, the substrate includes a width dimension (W) defined as a first maximum dimension of one of the first or second major surfaces 112, 114 orthogonal to the thickness (t), and a length dimension (L) defined as a second maximum dimension of one of the first or second major surfaces 112, 114 orthogonal to both the thickness and the width. In other embodiments, the dimensions discussed herein may be average dimensions.

In one or more embodiments, the substrate has a thickness (t) that is about 2 millimeters (mm) or less. For example, the thickness may be in a range from about 0.1 mm to about 2 mm, from about 0.15 mm to about 2 mm, 0.2 mm to about 2 mm, from about 0.25 mm to about 2 mm, 0.3 mm to about 2 mm, from about 0.35 mm to about 2 mm, 0.4 mm to about 2 mm, from about 0.45 mm to about 2 mm, 0.5 mm to about 2 mm, from about 0.55 mm to about 2 mm, 0.6 mm to about 2 mm, from about 0.65 mm to about 2 mm, 0.7 mm to about 2 mm, from about 0.75 mm to about 2 mm, 0.8 mm to about 2 mm, 0.9 mm to about 2 mm, from about 0.95 mm to about 2 mm, from about 1 mm to about 2 mm, from about 1.2 mm to about 2 mm, from about 1.4 mm to about 2 mm, from about 1.5 mm to about 2 mm, from about 0.15 mm to about 0.95 mm, 0.2 mm to about 0.9 mm, from about 0.25 mm to about 0.85 mm, 0.3 mm to about 0.8 mm, from about 0.35 mm to about 0.75 mm, 0.4 mm to about 0.7 mm, from about 0.45 mm to about 0.65 mm, 0.5 mm to about 0.7 mm, from about 0.15 mm to about 1 mm, 0.2 mm to about 1 mm, from about 0.25 mm to about 1 mm, 0.3 mm to about 1 mm, from about 0.35 mm to about 1 mm, 0.4 mm to about 1 mm, 0.45 mm to about 1 mm, from about 0.5 mm to about 1 mm, from about 0.1 mm to about 1.8 mm, from about 0.1 mm to about 1.6 mm, from about 0.1 mm to about 1.5 mm, from about 0.1 mm to about 1.4 mm, from about 0.1 mm to about 1.3 mm, from about 0.1 mm to about 1.2 mm, from about 0.1 mm to about 1.1 mm, from about 0.1 mm to about 1.05 mm, from about 0.1 mm to about 1 mm, from about 0.1 mm to about 0.95 mm, from about 0.1 mm to about 0.9 mm, from about 0.1 mm to about 0.85 mm, from about 0.1 mm to about 0.8 mm, from about 0.1 mm to about 0.75 mm, from about 0.1 mm to about 0.7 mm, from about 0.1 mm to about 0.65 mm, from about 0.1 mm to about 0.6 mm, from about 0.1 mm to about 0.55 mm, from about 0.1 mm to about 0.5 mm, from about 0.1 mm to about 0.4 mm, or from about 0.3 mm to about 0.7 mm.

In one or more embodiments, the substrate has a width dimension (W) in a range from about 3 centimeters (cm) to about 50 cm, from about 4 cm to about 50 cm, from about 5 cm to about 50 cm, from about 6 cm to about 50 cm, from about 8 cm to about 50 cm, from about 10 cm to about 50 cm, from about 15 cm to about 50 cm, from about 20 cm to about 50 cm, from about 25 cm to about 50 cm, from about 30 cm to about 50 cm, from about 35 cm to about 50 cm, from about 40 cm to about 50 cm, from about 3 cm to about 45 cm, from about 3 cm to about 40 cm, from about 3 cm to about 35 cm, from about 3 cm to about 30 cm, from about 3 cm to about 25 cm, from about 3 cm to about 20 cm, from about 3 cm to about 18 cm, from about 2 cm to about 16 cm, from about 3 cm to about 15 cm, from about 3 cm to about 14 cm, from about 3 cm to about 12 cm, from about 3 cm to about 10 cm, from about 3 cm to about 8 cm, from about 3 cm to about 6 cm, or from about 3 cm to about 5 cm. In one or more embodiments, the width dimension (W) is larger and may be in a range from about 5 cm to about 100 cm, from about 10 cm to about 100 cm, from about 15 cm to about 100 cm, from about 20 cm to about 100 cm, from about 25 cm to about 100 cm, from about 30 cm to about 100 cm, from about 35 cm to about 100 cm, from about 40 cm to about 100 cm, from about 45 cm to about 100 cm, from about 50 cm to about 100 cm, from about 55 cm to about 100 cm, from about 60 cm to about 100 cm, from about 65 cm to about 100 cm, from about 75 cm to about 100 cm, from about 5 cm to about 95 cm, from about 5 cm to about 90 cm, from about 5 cm to about 85 cm, from about 5 cm to about 80 cm, from about 5 cm to about 75 cm, from about 5 cm to about 70 cm, from about 5 cm to about 65 cm, from about 5 cm to about 60 cm, from about 5 cm to about 55 cm, from about 5 cm to about 50 cm, from about 5 cm to about 45 cm, from about 5 cm to about 40 cm, from about 5 cm to about 35 cm, from about 25 cm to about 70 cm, or from about 30 cm to about 65 cm.

In one or more embodiments, the substrate has a length dimension (L) in a range from about 3 cm to about 50 cm, from about 4 cm to about 50 cm, from about 5 cm to about 50 cm, from about 6 cm to about 50 cm, from about 8 cm to about 50 cm, from about 10 cm to about 50 cm, from about 15 cm to about 50 cm, from about 20 cm to about 50 cm, from about 25 cm to about 50 cm, from about 30 cm to about 50 cm, from about 35 cm to about 50 cm, from about 40 cm to about 50 cm, from about 3 cm to about 45 cm, from about 3 cm to about 40 cm, from about 3 cm to about 35 cm, from about 3 cm to about 30 cm, from about 3 cm to about 25 cm, from about 3 cm to about 20 cm, from about 3 cm to about 18 cm, from about 2 cm to about 16 cm, from about 3 cm to about 15 cm, from about 3 cm to about 14 cm, from about 3 cm to about 12 cm, from about 3 cm to about 10 cm, from about 3 cm to about 8 cm, from about 3 cm to about 6 cm, or from about 3 cm to about 5 cm. In one or more embodiments, the length dimension (L) is larger and may be in a range from about 5 cm to about 100 cm, from about 10 cm to about 100 cm, from about 15 cm to about 100 cm, from about 20 cm to about 100 cm, from about 25 cm to about 100 cm, from about 30 cm to about 100 cm, from about 35 cm to about 100 cm, from about 40 cm to about 100 cm, from about 45 cm to about 100 cm, from about 50 cm to about 100 cm, from about 55 cm to about 100 cm, from about 60 cm to about 100 cm, from about 65 cm to about 100 cm, from about 75 cm to about 100 cm, from about 5 cm to about 95 cm, from about 5 cm to about 90 cm, from about 5 cm to about 85 cm, from about 5 cm to about 80 cm, from about 5 cm to about 75 cm, from about 5 cm to about 70 cm, from about 5 cm to about 65 cm, from about 5 cm to about 60 cm, from about 5 cm to about 55 cm, from about 5 cm to about 50 cm, from about 5 cm to about 45 cm, from about 5 cm to about 40 cm, from about 5 cm to about 35 cm, from about 25 cm to about 70 cm, or from about 30 cm to about 65 cm.

In one or more embodiments the width dimension (W) and length dimension (L) are substantially equal. In one or more embodiments, the width dimension (W) is less than the length (L) dimension. In one or more embodiments, the length dimension (L) is less than the width (W) dimension.

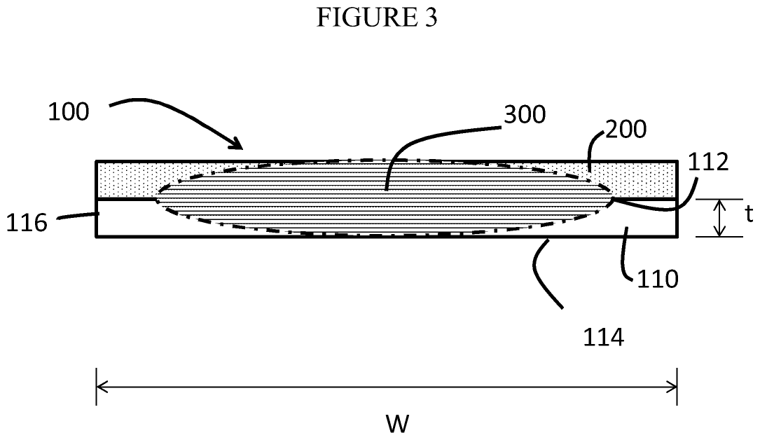

As shown in FIG. 3, in one or more embodiments, the optical system includes an optical region 300 having an optical region dimension. In one or more embodiments, the optical region dimension of the optical region 300 is the maximum dimension of the optical region 300. In one or more embodiments, the optical region dimension is less than one or both of the length dimension (L) and the width dimension (W) of the substrate. In one or more alternative embodiments, the optical region dimension is equal to one or both of the length dimension (L) and the width dimension (W). In one or more embodiments, the anti-reflection layer 200 is disposed on at least the entirety of the optical region dimension of the optical region 300. As shown in FIG. 3, the anti-reflection layer 200 is disposed on the entirety of the optical region dimension and up to the entirety of one or both of the first major surface 112 and the second major surface 114 of the substrate. Described in a different way, the anti-reflection layer 200 is disposed on the entirety of the optical region dimension of the optical region and up to 100% of one or both of the length dimension (L) and width dimension (W).

In one or more embodiments, the optical region 300 can be described as a region through which a user looks through. In one or more embodiments, optical region 300 is a region having larger width and length dimensions than a region of the optical system that includes grating elements. In some embodiments, the optical region includes at least one of an in-coupling region, a cross-coupling region, and an out-coupling region. In some specific embodiments, the optical region includes two of or all three of an in-coupling region, a cross-coupling region, and an out-coupling region. As used herein, the in-coupling region, a cross-coupling region and an out-coupling region are used to direct light into, through and out of the substrate. Some embodiments, the optical region acts as waveguide or lightguide.

In one or more embodiments, the optical region dimension is in a range from about 15 mm to about 150 mm. In one or more embodiments, the optical region dimension is in a range from about 30 mm to about 150 mm, from about 30 mm to about 65 mm, from about 100 mm to about 150 mm, or from about 15 mm to about 33 mm, over a field of view (FOV) up to 80 degrees. In one or more embodiments, the optical region dimension, over a FOV of up to 80 degrees, is in a range from about 20 mm to about 150 mm, from about 22 mm to about 150 mm, from about 24 mm to about 150 mm, from about 25 mm to about 150 mm, from about 26 mm to about 150 mm, from about 28 mm to about 150 mm, from about 30 mm to about 150 mm, from about 32 mm to about 150 mm, from about 34 mm to about 150 mm, from about 35 mm to about 150 mm, from about 40 mm to about 150 mm, from about 45 mm to about 150 mm, from about 50 mm to about 150 mm, from about 15 mm to about 145 mm, from about 15 mm to about 140 mm, from about 15 mm to about 135 mm, from about 15 mm to about 130 mm, from about 15 mm to about 125 mm, from about 15 mm to about 120 mm, from about 15 mm to about 115 mm, from about 15 mm to about 110 mm, from about 15 mm to about 105 mm, from about 15 mm to about 100 mm, from about 15 mm to about 95 mm, from about 15 mm to about 90 mm, from about 15 mm to about 85 mm, from about 15 mm to about 80 mm, from about 15 mm to about 75 mm, from about 15 mm to about 70 mm, from about 15 mm to about 65 mm, from about 15 mm to about 60 mm, from about 15 mm to about 55 mm, from about 30 mm to about 60 mm, from about 30 mm to about 55 mm, from about 30 mm to about 50 mm, from about 30 mm to about 45 mm, from about 30 mm to about 40 mm, from about 30 mm to about 35 mm, from about 50 mm to about 60 mm, from about 50 mm to about 55 mm, from about 15 mm to about 60 mm, from about 15 mm to about 55 mm, from about 15 mm to about 50 mm, from about 15 mm to about 45 mm, from about 15 mm to about 40 mm, from about 15 to about 35 mm, from about 65 mm to about 150 mm, from about 70 mm to about 150 mm, from about 75 mm to about 150 mm, from about 80 mm to about 150 mm, from about 85 mm to about 150 mm, from about 90 mm to about 150 mm, from about 95 mm to about 150 mm, from about 100 mm to about 150 mm, from about 65 mm to about 145 mm, from about 65 mm to about 140 mm, from about 65 mm to about 135 mm, from about 65 mm to about 130 mm, from about 65 mm to about 125 mm, from about 65 mm to about 120 mm, from about 65 mm to about 115 mm, from about 65 mm to about 110 mm, or from about 65 mm to about 105 mm, or from about 65 mm to about 100 mm. In one or more embodiments, the disclosed optical region dimension ranges are over a FOV in a range from about 2 degrees to about 80 degrees, from about 5 degrees to about 80 degrees, from about 10 degrees to about 80 degrees, from about 15 degrees to about 80 degrees, from about 20 degrees to about 80 degrees, from about 25 degrees to about 80 degrees, from about 30 degrees to about 80 degrees, from about 35 degrees to about 80 degrees, from about 40 degrees to about 80 degrees, from about 45 degrees to about 80 degrees, from about 50 degrees to about 80 degrees, from about 55 degrees to about 80 degrees, from about 60 degrees to about 80 degrees, from about 65 degrees to about 80 degrees, from about 70 degrees to about 80 degrees, from about 5 degrees to about 75 degrees, from about 5 degrees to about 70 degrees, from about 5 degrees to about 65 degrees, from about 5 degrees to about 60 degrees, from about 5 degrees to about 55 degrees, from about 5 degrees to about 50 degrees, from about 5 degrees to about 45 degrees, from about 5 degrees to about 40 degrees, from about 5 degrees to about 35 degrees, from about 5 degrees to about 25 degrees, from about 5 degrees to about 20 degrees, or from about 5 degrees to about 70 degrees.

The foregoing optical region dimension ranges and FOV ranges are based on an eye relief distance, which is the distance between the eye and the physical optical system, in a range from about 5 mm to about 30 mm, and a maximum dimension of eye box in a range from about 5 mm to about 30 mm. In one or more embodiments, one of or both the eye relief distance and maximum dimension of eye box is in a range from about 5 mm to about 28 mm, from about 5 mm to about 26 mm, from about 5 mm to about 25 mm, from about 5 mm to about 24 mm, from about 5 mm to about 22 mm, from about 5 mm to about 20 mm, from about 5 mm to about 18 mm, from about 5 mm to about 16 mm, from about 5 mm to about 15 mm, from about 6 mm to about 30 mm, from about 8 mm to about 30 mm, from about 10 mm to about 30 mm, from about 12 mm to about 30 mm, from about 14 mm to about 30 mm, from about 15 mm to about 30 mm, from about 16 mm to about 30 mm, from about 18 mm to about 30 mm, from about 20 mm to about 30 mm, from about 10 mm to about 25 mm, from about 10 mm to about 20 mm, or from about 15 mm to about 20 mm.

In one or more embodiments, the modulus of elasticity of the substrate is greater than 60 GPa, greater than 80 GPa, greater than 100 GPa, greater than 110 GPa. In one or more embodiments, the modulus of elasticity of the substrate is less than 160 GPa, less than 150 GPa, less than 130 GPa, or less than 120 GPa. Accordingly, the substrate has a modulus of elasticity such that when 500 kPa of tensile stress is applied to the substrate, the substrate strains no more than 5.5 μm/m but at least 3.1 μm/m, such as no more than 5.2 μm but at least 4.3 μm.

By contrast, the elastic modulus of the anti-reflective layer 200 is less than 1.1 times the modulus of elasticity of the substrate over a common stress range (such as at some, most, or all stresses within an elastic regime of the respective material) or over a common amount of strain (such as an amount between 0 and the fracture strain of the substrate, on average; e.g., between strains of the substrate corresponding to 0 and 500 kPa tensile load). In at least some such instances, the modulus of elasticity of the anti-reflection layer is less than that of the substrate. In some examples, the modulus of elasticity of the anti-reflection layer is at least 10 GPa less, at least 20 GPa less, at least 30 GPa less. In some embodiments, the anti-reflection layer has a modulus of elasticity that is in a range from about 0.1 to about 1 times, from at least 0.3 times to about 1.1 times, from at least 0.5 times to about 1.1 times, from at least 0.7 times to about 1.1 times, from at least 0.9 times to about 1.1 times, from at least 1 time to about 1.1 times, from at least 0.1 times to about 0.9 times, from at least 0.1 times to about 0.7 times, from at least 0.1 times to about 0.5 times, or from at least 0.1 times to about 0.3 times, the modulus of elasticity of the substrate.

In one or more embodiments, while the modulus of elasticity of the anti-reflection layer may be less than about 1.1 times the modulus of elasticity of the substrate, the modulus of elasticity of the anti-reflection layer should at least be stiff enough to sufficiently constrain cracks on a surface of the underlying substrate. According to one or more specific embodiments, a modulus of elasticity of the anti-reflective layer 200 is from about 500 kPa to about 150 GPa, from about 1 GPa to about 150 GPa, from about 10 GPa to about 150 GPa, from about 20 GPa to about 150 GPa, from about 25 GPa to about 150 GPa, from at least 50 GPa to about 150 GPa, from about 60 GPa to about 150 GPa, from about 500 kPa to about 140 GPa, from about 500 kPa to about 130 GPa, from about 500 kPa to about 120 GPa, from about 500 kPa to about 110 GPa, from about 500 kPa to about 100 GPa, from about 500 kPa to about 90 GPa, from about 500 kPa to about 80 GPa, from about 500 kPa to about 70 GPa, from about 500 kPa to about 60 GPa, or from about 500 kPa to about 50 GPa.

As used herein, total internal reflection (TIR) means reflection when the incidence angle in the substrate and anti-reflection layer is greater than the critical angle at the boundary of the substrate (and any intervening layers) and air. In one or more embodiments, the TIR takes into account losses from the anti-reflection layer. When the critical angle is exceeded, light is then reflected back into the substrate, with a reflectance of 100%, in the case of no losses (e.g., due to absorption or scattering in the anti-reflection layer 200).

In one or more embodiments, when measured at the anti-reflection layer 200, the substrate and anti-reflection layer comprises a substrate-side anti-reflection layer mediated total internal reflection (TIR) reflectance. As used herein, the phrase “anti-reflection layer mediated TIR” (in terms of reflectance and transmittance) means the TIR taking into account optical loss caused by the anti-reflection layer in a single interaction [these values are calculated with measurements using Metricon] reduces the TIR reflectance from 100% to a value less than 100%. Optical loss may be due to absorption of the layer materials, scattering due to the layer morphology and defects, or other causes. In one or more embodiments, such anti-reflection layer mediated TIR is less than 100%. In one or more specific embodiments, when measured at the anti-reflection layer 200, the substrate and anti-reflection layer comprises a substrate-side anti-reflection layer mediated total internal reflection (TIR) reflectance of at least 95% (e.g., at least 95.5%, at least 96%, at least 96.5%, at least 97%, at least 97.5%, at least 98%, at least 98.2%, at least 98.4%, at least 98.5%, at least 98.6%, at least 98.8%, at least 99%, at least 99.2%, at least 99.4%, at least 99.5%, at least 99.6%, at least 99.4%, or at least 99.5%). In one or more embodiments, the substrate and anti-reflection layer comprises a substrate-side anti-reflection layer mediated total internal reflection (TIR) reflectance in a range from about 95% and up to about 100%, from about 95.5% and up to about 100%, from about 96% and up to about 100%, from about 96.5% and up to about 100%, from about 97% and up to about 100%, from about 97.5% and up to about 100%, from about 98% and up to about 100%, from about 98.5% and up to about 100%, from about 99% and up to about 100%, from about 99.5% and up to about 100%, from about 95% to about 99.5%, from about 95% to about 99%, from about 95% to about 98.5%, from about 95% to about 98%, from about 95% to about 97.5%, from about 95% to about 97%, from about 95% to about 96.5%, from about 95% to about 96%, from about 95% to about 99.9%, from about 95% to about 99.8%, from about 95% to about 99.7%, from about 95% to about 99.6%, from about 95% to about 99.5%, from about 95% to about 99.4%, from about 95% to about 99.3%, from about 95% to about 99.2%, or from about 95% to about 99.1%.

In one or more embodiments, when measured at the anti-reflection layer 200, the substrate and anti-reflection layer comprises an air-side reflectance at an incidence angle up to ±60 degrees of less than 8% (e.g., less than 7.5%, less than 7%, less than 6.5%, less than 6%, less than 5.5%, less than 5%, less than 4.5%, less than 4%, less than 3.5%, less than 3%, less than 2.5%, less than 2%, less than 1.5%), in the visible spectrum from about 450 nm to 650 nm. The air-side reflectance may be at least 0.01% up to about 8%, or any range or subrange disclosed herein. In one or more embodiments, the air-side reflectance may be in a range from about 0.02% up to about 8%, from about 0.03% up to about 8%, from about 0.04% up to about 8%, from about 0.05% up to about 8%, from about 0.06% up to about 8%, from about 0.07% up to about 8%, from about 0.08% up to about 8%, from about 0.09% up to about 8%, from about 0.1% up to about 8%, from about 0.15% up to about 8%, from about 0.2% up to about 8%, from about 0.25% up to about 8%, from about 0.3% up to about 8%, from about 0.35% up to about 8%, from about 0.4% up to about 8%, from about 0.5% up to about 8%, from about 0.75% up to about 8%, from about 1% up to about 8%, from about 2% up to about 8%, from about 3% up to about 8%, from about 4% up to about 8%, from about 0.01% up to about 7%, from about 0.01% up to about 6%, from about 0.01% up to about 5%, from about 0.01% up to about 4%, from about 0.01% up to about 3%, from about 0.01% up to about 2%, from about 0.01% up to about 1%, from about 0.1% up to about 3%, from about 0.1% up to about 2%, from about 0, 1% up to about 1%, from about 0.05% up to about 2%, or from about 0.075% up to about 2%.

In some embodiments, when measured at the anti-reflection layer 200, the substrate and anti-reflection layer comprises a substrate-side anti-reflection layer mediated total internal reflection (TIR) reflectance of at least 95% (e.g., at least 95.5%, at least 96%, at least 96.5%, at least 97%, at least 97.5%, at least 98%, at least 98.2%, at least 98.4%, at least 98.5%, at least 98.6%, at least 98.8%, at least 99%, at least 99.2%, at least 99.4%, at least 99.5%, at least 99.6%, at least 99.4%, or at least 99.5%). In one or more embodiments, when measured at the anti-reflection layer 200, the substrate and anti-reflection layer comprises a substrate-side anti-reflection layer mediated total internal reflection (TIR) reflectance in a range from about 95% and up to about 100%, from about 95.5% and up to about 100%, from about 96% and up to about 100%, from about 96.5% and up to about 100%, from about 97% and up to about 100%, from about 97.5% and up to about 100%, from about 98% and up to about 100%, from about 98.5% and up to about 100%, from about 99% and up to about 100%, from about 99.5% and up to about 100%, from about 95% to about 99.5%, from about 95% to about 99%, from about 95% to about 98.5%, from about 95% to about 98%, from about 95% to about 97.5%, from about 95% to about 97%, from about 95% to about 96.5%, from about 95% to about 96%, from about 95% to about 99.9%, from about 95% to about 99.8%, from about 95% to about 99.7%, from about 95% to about 99.6%, from about 95% to about 99.5%, from about 95% to about 99.4%, from about 95% to about 99.3%, from about 95% to about 99.2%, or from about 95% to about 99.1%.

In one or more embodiments, when measured at the anti-reflection layer 200, the substrate and anti-reflection layer comprises an air-side reflectance at an incidence angle up to #60 degrees of less than 8% (e.g., less than 7.5%, less than 7%, less than 6.5%, less than 6%, less than 5.5%, less than 5%, less than 4.5%, less than 4%, less than 3.5%, less than 3%, less than 2.5%, less than 2%, or less than 1.5%), along at least 50% or along the entire visible spectrum from about 450 nm to 650 nm. The air-side reflectance may be at least 0.01% up to about 8%, or any range or subrange disclosed herein. In one or more embodiments, when measured at the anti-reflection layer 200, the substrate and anti-reflection layer comprises an air-side reflectance in a range from about 0.02% up to about 8%, from about 0.03% up to about 8%, from about 0.04% up to about 8%, from about 0.05% up to about 8%, from about 0.06% up to about 8%, from about 0.07% up to about 8%, from about 0.08% up to about 8%, from about 0.09% up to about 8%, from about 0.1% up to about 8%, from about 0.15% up to about 8%, from about 0.2% up to about 8%, from about 0.25% up to about 8%, from about 0.3% up to about 8%, from about 0.35% up to about 8%, from about 0.4% up to about 8%, from about 0.5% up to about 8%, from about 0.75% up to about 8%, from about 1% up to about 8%, from about 2% up to about 8%, from about 3% up to about 8%, from about 4% up to about 8%, from about 0.01% up to about 7%, from about 0.01% up to about 6%, from about 0.01% up to about 5%, from about 0.01% up to about 4%, from about 0.01% up to about 3%, from about 0.01% up to about 2%, from about 0.01% up to about 1%, from about 0.1% up to about 3%, from about 0.1% up to about 2%, from about 0, 1% up to about 1%, from about 0.05% up to about 2%, or from about 0.075% up to about 2%.

In one or more embodiments, when measured at the anti-reflection layer 200, the substrate and anti-reflection layer comprises a substrate-side anti-reflection layer mediated total internal reflection (TIR) reflectance of at least 95% (e.g., at least 95.5%, at least 96%, at least 96.5%, at least 97%, at least 97.5%, at least 98%, at least 98.2%, at least 98.4%, at least 98.5%, at least 98.6%, at least 98.8%, at least 99%, at least 99.2%, at least 99.4%, at least 99.5%, at least 99.6%, at least 99.4%, or at least 99.5%). In one or more embodiments, when measured at the anti-reflection layer 200, the substrate and anti-reflection layer comprises a substrate-side anti-reflection layer mediated total internal reflection (TIR) reflectance in a range from about 95% and up to about 100%, from about 95.5% and up to about 100%, from about 96% and up to about 100%, from about 96.5% and up to about 100%, from about 97% and up to about 100%, from about 97.5% and up to about 100%, from about 98% and up to about 100%, from about 98.5% and up to about 100%, from about 99% and up to about 100%, from about 99.5% and up to about 100%, from about 95% to about 99.5%, from about 95% to about 99%, from about 95% to about 98.5%, from about 95% to about 98%, from about 95% to about 97.5%, from about 95% to about 97%, from about 95% to about 96.5%, from about 95% to about 96%, from about 95% to about 99.9%, from about 95% to about 99.8%, from about 95% to about 99.7%, from about 95% to about 99.6%, from about 95% to about 99.5%, from about 95% to about 99.4%, from about 95% to about 99.3%, from about 95% to about 99.2%, or from about 95% to about 99.1%.

In one or more embodiments, when measured at the anti-reflection layer 200, the substrate and anti-reflection layer comprises an air-side reflectance at an incidence angle up to #60 degrees of less than 8% (e.g., less than 7.5%, less than 7%, less than 6.5%, less than 6%, less than 5.5%, less than 5%, less than 4.5%, less than 4%, less than 3.5%, less than 3%, less than 2.5%, less than 2%, or less than 1.5%), in the visible spectrum from about 450 nm to 650 nm, along at least 50% or along the entire visible spectrum from about 450 nm to 650 nm. The air-side reflectance of such embodiments may be at least 0.01% up to about 8%, or any range or subrange disclosed herein. In one or more embodiments, the air-side reflectance of such embodiments is in a range from about 0.02% up to about 8%, from about 0.03% up to about 8%, from about 0.04% up to about 8%, from about 0.05% up to about 8%, from about 0.06% up to about 8%, from about 0.07% up to about 8%, from about 0.08% up to about 8%, from about 0.09% up to about 8%, from about 0.1% up to about 8%, from about 0.15% up to about 8%, from about 0.2% up to about 8%, from about 0.25% up to about 8%, from about 0.3% up to about 8%, from about 0.35% up to about 8%, from about 0.4% up to about 8%, from about 0.5% up to about 8%, from about 0.75% up to about 8%, from about 1% up to about 8%, from about 2% up to about 8%, from about 3% up to about 8%, from about 4% up to about 8%, from about 0.01% up to about 7%, from about 0.01% up to about 6%, from about 0.01% up to about 5%, from about 0.01% up to about 4%, from about 0.01% up to about 3%, from about 0.01% up to about 2%, from about 0.01% up to about 1%, from about 0.1% up to about 3%, from about 0.1% up to about 2%, from about 0, 1% up to about 1%, from about 0.05% up to about 2%, or from about 0.075% up to about 2%.

In one or more embodiments, the substrate comprises a glass crack onset strain, and the anti-reflection layer comprises a layer crack onset strain that is greater than the glass crack onset strain. In such embodiments, the substrate comprises a glass-based substrate, as described herein.

According to one or more embodiments, the anti-reflection layer 200, an elastic behavior regime of the anti-reflection layer fully overlaps a range of zero strain to fracture strain of the layer 110. Accordingly, if the optical system 100 is stretched and relaxed without breaking the substrate 110, the anti-reflection layer 200 operates within the elastic regime thereof.

### Anti-Reflection Layer

In one or more embodiments, the anti-reflection layer 200 is a single layer or is multilayer. In or more embodiments, the anti-reflection layer 200 includes alternating sublayers of a high refractive index material and a low refractive index material. In one or more embodiments, the anti-reflective layer 200 may include at least one sublayer or more. In some embodiments, the sublayers may include a functional layer that provides adhesion or other properties. In some embodiments, the anti-reflective layer 200 may include 6 sublayers or more. In some embodiments, the anti-reflective layer may include more than 20 sublayers. In one or more embodiments, a high refractive index material may exhibit a refractive index measured at a wavelength of 589 nm of 1.7 or greater. In one or more embodiments, a low refractive index material may exhibit a refractive index measured at a wavelength of 589 nm of less than 1.7. In one or more embodiments, a high refractive index material exhibits a refractive index measured at a wavelength of 589 nm that is at least 0.1 greater than the refractive index of the low refractive index material. Examples of suitable high refractive index materials include, without limitation, SiᵤAlᵥOₓN_{y}, Ta₂O₅, Nb₂O₅, AlN, Si₃N₄, AlOₓN_{y}, SiOₓN_{y}, HfO₂, TiO₂, ZrO₂, Y₂O₃, Al₂O₃, and MoO₃. Examples of suitable low refractive index materials include, without limitation, SiO₂, Al₂O₃, GeO₂, SiO, AlOₓN_{y}, SiOₓN_{y}, Si AlᵥOₓN_{y}, MgO, MgF₂, BaF₂, CaF₂, DyF₃, YbF₃, YF₃, and CeF₃. The thickness of the anti-reflection layer may be in a range from about 10 nm to about 4000 nm. In one or more embodiments, the anti-reflection layer has a thickness in a range from about 20 nm to about 4000 nm, from about 40 nm to about 4000 nm, from about 50 nm to about 4000 nm, from about 60 nm to about 4000 nm, from about 80 nm to about 4000 nm, from about 100 nm to about 4000 nm, from about 150 nm to about 4000 nm, from about 200 nm to about 4000 nm, from about 250 nm to about 4000 nm, from about 300 nm to about 4000 nm, from about 350 nm to about 4000 nm, from about 400 nm to about 4000 nm, from about 500 nm to about 4000 nm, from about 750 nm to about 4000 nm, from about 1000 nm to about 4000 nm, from about 1500 nm to about 4000 nm, from about 2000 nm to about 4000 nm, from about 2500 nm to about 4000 nm, from about 3000 nm to about 4000 nm, from about 10 nm to about 3500 nm, from about 10 nm to about 3000 nm, from about 10 nm to about 2500 nm, from about 10 nm to about 2000 nm, from about 10 nm to about 1500 nm, from about 10 nm to about 1000 nm, from about 10 nm to about 800 nm, from about 10 nm to about 700 nm, from about 10 nm to about 600 nm, from about 10 nm to about 500 nm, from about 10 nm to about 400 nm, from about 10 nm to about 300 nm, from about 10 nm to about 250 nm, from about 10 nm to about 200 nm, from about 50 nm to about 200 nm, from about 250 nm to about 1000 nm, or from about 500 nm to about 2000 nm. In some embodiments, the anti-reflection layer (and any sublayer(s)) may be measured in terms of optical thickness (n*d). In one or more embodiment, each sublayer may have an optical thickness in the range from about 2 nm to about 200 nm. In one or more embodiments, the anti-reflection layer may include one or more sublayers that imparts hardness to the optical system 100. In such embodiments, the one or more sublayers may be described as hard sublayers. Hardness of the optical system 100 may be measured as a surface hardness. In one or more embodiments, the optical system 100, including one or more hard sublayers, may exhibit an average hardness in a range from about 5 GPa to about 30 GPa as measured on the anti-reflective layer side by indenting the anti-reflective layer with a Berkovitch indenter to form an indent having an indentation depth of at least about 100 nm from the surface of the anti-reflective layer. In some embodiments, the average hardness of the optical system 100 may be in the range from about 6 GPa to about 30 GPa, from about 7 GPa to about 30 GPa, from about 8 GPa to about 30 GPa, from about 9 GPa to about 30 GPa, from about 10 GPa to about 30 GPa, from about 12 GPa to about 30 GPa, from about 5 GPa to about 28 GPa, from about 5 GPa to about 26 GPa, from about 5 GPa to about 24 GPa, from about 5 GPa to about 22 GPa, from about 5 GPa to about 20 GPa, from about 12 GPa to about 25 GPa, from about 15 GPa to about 25 GPa, from about 16 GPa to about 24 GPa, from about 18 GPa to about 22 GPa and all ranges and sub-ranges therebetween. In one or more embodiments, the hard sublayers may exhibit a refractive index of about 1.7 or greater. In one or more embodiments, one or more of the hard sublayers may include one or more of AlN, Si₃N₄, AlOₓN_{y}, SiOₓN_{y}, Al₂O₃, SiₓC_{y}, SiₓO_{y}C_{z}, ZrO₂, TiOₓN_{y}, diamond, diamond-like carbon, and SiᵤAlᵥOₓN_{y}.

In embodiments in which the anti-reflection layer 200 is a single layer, the single layer may include MgF₂ or other similar material that bridges the refractive index of the substrate and the air (or optically smooths out the refractive index between the two). In some embodiments, the single layer is uniform in composition, or other properties, or is a gradient.

### Substrate

In one or more embodiments, the substrate 110 may comprise an inorganic material, an organic material, or a combination thereof. In one or more embodiments, the substrate has a refractive index of greater than 1.55 at a wavelength of 589 nm. In one or more embodiments, the substrate refractive index is greater than 1.60, greater than 1.70, greater than 1.80, greater than 1.90, greater than 2.00, greater than 2.10, or greater than 2.2. In some embodiments, the refractive index of the substrate has a refractive index in a range from 1.60 to 2.40, in a range from 1.70 to 2.20, in a range from 1.80 to 2.10, or in a range from 1.90 to 2.00.

In one or more embodiments, the substrate may be transparent (defined as having a transmittance greater than 90% over a wavelength range from 450 nm to 650 nm) or opaque (defined as having a transmittance less than 20% over a wavelength range from 450 nm to 650 nm). In one or more embodiments, the substrate may include a colorant that provides a specific color.

The substrate 110 may be formed from man-made materials and/or naturally occurring materials (e.g., quartz and polymers). For example, in some instances, the substrate 110 may be characterized as organic and may specifically be polymeric. Examples of suitable polymers include, without limitation: thermoplastics including polystyrene (PS) (including styrene copolymers and blends), polycarbonate (PC) (including copolymers and blends), polyesters (including copolymers and blends, including polyethyleneterephthalate and polyethyleneterephthalate copolymers), polyolefins (PO) and cyclicpolyolefins (cyclic-PO), polyvinylchloride (PVC), acrylic polymers including polymethyl methacrylate (PMMA) (including copolymers and blends), thermoplastic urethanes (TPU), polyetherimide (PEI) and blends of these polymers with each other. Other exemplary polymers include epoxy, styrenic, phenolic, melamine, and silicone resins. Other examples of substrates include ringed or sulfur-based polymers that are thermoplastics to thermosets

In some specific embodiments, the substrate 110 may specifically exclude polymeric, plastic and/or metal substrates.

In one or more embodiments, the substrate 110 includes an inorganic material, which may be an amorphous substrate, a crystalline substrate or a combination thereof.

In one or more embodiments, the substrate 110 is a glass-based substrate. As used herein, the term “glass-based substrate” is used in its broadest sense to include any object made wholly or partly of glass. In one or embodiments, the glass-based substrate comprises an amorphous glass material. In one or more specific embodiments, the glass-based substrate is substantially free of crystals or crystalline phases. Examples of glass-based substrates comprise aluminosilicate glass, soda lime silicate glass, lithium aluminosilicate glass, borosilicate glass, boroaluminosilciate glass, and the like. In one or more embodiments, the glass-based substrate may be alkali oxide-containing (e.g., Li₂O, Na₂O, K₂O, etc.). In one or more embodiments, the glass-based substrate may include a glass-ceramic, which includes an amorphous phase and a crystalline phase. In one or more embodiments, glass-based substrate include laminates of glass and non-glass materials, laminates of glass and crystalline materials.

In one or more embodiments, the glass-based substrate has a refractive index of greater than 1.55 at a wavelength of 589 nm. In one or more embodiments, the substrate refractive index is greater than 1.60, greater than 1.70, greater than 1.80, greater than 1.90, greater than 2.00, greater than 2.10, or greater than 2.2. In some embodiments, the refractive index of the substrate has a refractive index in a range from 1.60 to 2.40, in a range from 1.70 to 2.20, in a range from 1.80 to 2.10, or in a range from 1.90 to 2.00.

In one or more embodiments, the glass-based substrate may be strengthened. In one or more embodiments, the glass-based substrate may be thermally, chemically or mechanically strengthened. In one or more embodiments, the glass-based substrate may be thermally and chemically strengthened, thermally and mechanically strengthened, or chemically and mechanically strengthened. In one or more embodiments, the glass-based substrate is mechanically strengthened by utilizing a mismatch of the coefficient of thermal expansion between portions of the substrate to create a compressive stress region and a central region exhibiting a tensile stress. In some embodiments, the glass-based substrate may be thermally strengthened by heating the glass to a temperature above the glass transition point and then rapidly quenching. In one or more embodiments, the glass-based substrate may be chemically strengthening by an ion exchange process. In the ion exchange process, ions at or near the surface of the glass-based substrate are replaced by—or exchanged with—larger ions having the same valence or oxidation state. In those embodiments in which the glass-based substrate comprises an alkali aluminosilicate glass, smaller ions in a surface layer of the glass-based substrate are exchanged with larger ions, which may be monovalent alkali metal cations, such as Lit, Na+, K+, Rb+, and Cs+. Alternatively, monovalent cations in the surface layer may be replaced with monovalent cations other than alkali metal cations, such as Ag+ or the like. In such embodiments, the monovalent ions (or cations) exchanged into the glass-based substrate generate a compressive stress.

In one or more embodiments, the substrate is a lightguide. In one or more embodiments, the optical system further includes an input coupler; and an output coupler. In one or more embodiments, the optical system comprises a first region configured to receive light from an input coupler, a second region configured to transmit light through an output coupler, and an optical path between the first region and the second region. In one or more embodiments, the optical system 100 includes one or more gratings on one or both of the first major surface 112 and the second major surface 114 of the substrate which function as input and output couplers. In one or more embodiments, such gratings include an entrance grating and an exit grating. The substrate may include other gratings such as cross-coupling gratings and crossed exit gratings. Types of gratings can include, e.g., a surface relief grating (SRG), volume Bragg grating (VBG), or other suitable grating type or combination of grating types.

In one or more embodiments, the substrate has a density in a range from about 3 g/cm³ to about 6.5 g/cm³, 3.2 g/cm³ to about 6.5 g/cm³, 3.4 g/cm³ to about 6.5 g/cm³, 3.6 g/cm³ to about 6.5 g/cm³, from about 3.8 g/cm³ to about 6 g/cm³, from about 4 g/cm³ to about 6 g/cm³, from about 4.2 g/cm³ to about 6 g/cm³, from about 4.4 g/cm³ to about 6 g/cm³, from about 4.5 g/cm³ to about 6 g/cm³, from about 4.6 g/cm³ to about 6 g/cm³, from about 4.8 g/cm³ to about 6 g/cm³, from about 5 g/cm³ to about 6 g/cm³, from about 5.2 g/cm³ to about 6 g/cm³, from about 5.4 g/cm³ to about 6 g/cm³, from about 5.5 g/cm³ to about 6 g/cm³, from about 3 g/cm³ to about 5.8 g/cm³, from about 3 g/cm³ to about 5.6 g/cm³, from about 3 g/cm³ to about 5.5 g/cm³, from about 3 g/cm³ to about 5.4 g/cm³, from about 3 g/cm³ to about 5.2 g/cm³, from about 3 g/cm³ to about 5 g/cm³, from about 3 g/cm³ to about 4.8 g/cm³, from about 3 g/cm³ to about 4.6 g/cm³, from about 3 g/cm³ to about 4.5 g/cm³, from about 3 g/cm³ to about 4.4 g/cm³, from about 3 g/cm³ to about 4.2 g/cm³, or from about 3 g/cm³ to about 4 g/cm³.

In one or more embodiments, the substrate 100 has a weight of less than about 300 grams (g), less than 200 g, less than 100 g, less than 50 g, less than 25 g, less than 10 g, or less than 4 g. In one or more embodiments, the weight of the glass-based substrate is in a range from about 0.1 g to about 300 g, from about 0.5 g to about 300 g, from about 1 g to about 300 g, from about 1.5 g to about 300 g, from about 2 g to about 300 g, from about 2.5 g to about 300 g, from about 3 g to about 300 g, from about 3.5 g to about 300 g, from about 4 g to about 300 g, from about 4.5 g to about 300 g, from about 5 g to about 300 g, from about 10 g to about 300 g, from about 20 g to about 300 g, from about 30 g to about 300 g, from about 40 g to about 300 g, from about 50 g to about 300 g, from about 75 g to about 300 g, from about 100 g to about 300 g, from about 150 g to about 300 g, from about 200 g to about 300 g, from about 0.1 g to about 5 g, from about 0.25 g to about 5 g, from about 0.5 g to about 5 g, from about 1 g to about 5 g, from about 1.5 g to about 5 g, from about 2 g to about 5 g, from about 2.5 g to about 5 g, from about 3 g to about 5 g, from about 4 g to about 5 g, from about 1 g to about 4 g, from about 2 g to about 3 g, from about 2 g to about 4 g, from about 1 g to about 3 g, from about 0.1 g to about 4 g, from about 0.1 g to about 3 g, from about 0.1 g to about 2 g, from about 0.1 g to about 1 g, from about 0.5 g to about 4 g, from about 0.5 g to about 3 g, from about 0.5 g to about 2 g, or from about 0.5 g to about 1 g.

In one or more embodiments, the substrate is brittle. In one or more embodiments, the substrate 110 has a fracture toughness less than 0.9 MPa·m^{1/2}, such as less than 0.8 MPa·m^{1/2}, such as less than 0.75 MPa·m^{1/2}, such as less than 0.7 MPa·m^{1/2}, and/or at least 0.4 MPa·m^{1/2}, such as at least 0.5 MPa·m^{1/2}.

In some embodiments, the substrate 100 is curved and exhibits a radius of curvature. In one or more embodiments, the one or both of the first major surface 112 and the second major surface 114 comprises a first radius of curvature of less than 10,000 mm, less than 5,000 mm, less than 1,000 mm, less than 500 mm, or less than 100 mm. In some embodiments, the first radius of curvature is in a range from about from about 50 mm to about 10,000 mm, 60 mm to about 10,000 mm, 70 mm to about 10,000 mm, 80 mm to about 10,000 mm, 90 mm to about 10,000 mm, from about 100 mm to about 10,000 mm, from about 150 mm to about 10,000 mm, from about 200 mm to about 10,000 mm, from about 250 mm to about 10,000 mm, from about 300 mm to about 10,000 mm, from about 350 mm to about 10,000 mm, from about 400 mm to about 10,000 mm, from about 450 mm to about 10,000 mm, from about 500 mm to about 10,000 mm, from about 750 mm to about 10,000 mm, from about 1,000 mm to about 10,000 mm, from about 2000 mm to about 10,000 mm, from about 3000 mm to about 10,000 mm, from about 4000 mm to about 10,000 mm, from about 5000 mm to about 10,000 mm, from about 50 mm to about 9,000 mm, from about 50 mm to about 8,000 mm, from about 50 mm to about 7,000 mm, from about 50 mm to about 6,000 mm, from about 50 mm to about 5,000 mm, from about 50 mm to about 4,000 mm, from about 50 mm to about 3,000 mm, from about 50 mm to about 100 mm, from about 50 mm to about 100 mm, from about 60 mm to about 100 mm, from about 70 mm to about 100 mm, from about 50 mm to about 80 mm, from about 60 mm to about 80 mm, or from about 70 mm to about 80 mm. In one or more embodiments, the anti-reflection layer disposed on the substrate has substantially the same radius of curvature as the surface on which the anti-reflection layer is disposed (e.g., the first or second major surface, 112, 114).

In one more embodiments, the first radius of curvature differs from a second radius of curvature on the opposite major surface (112, 114). In one or more embodiments, the difference between the first radius of curvature and the second radius of curvature is about 100 mm, 200 mm, 300 mm, 400 mm or about 500 mm or less.

In one or more embodiments, the substrate 100 is cold-formed to exhibit such first or second radius of curvature. As used herein, the terms “cold-form” and “cold-formed” refer to curving the substrate at a cold-form temperature which is less than the softening point of the substrate. A feature of a cold-formed substrate is asymmetric surface compressive stress (CS) between the first major surface 112 and the second major surface 114. In one or more embodiments, prior to the cold-forming process or being cold-formed, the respective compressive stresses in the first major surface 112 and the second major surface 112 of the substrate are substantially equal. In one or more embodiments, after cold-forming, the compressive stress on the surface having a concave shape after bending increases. In other words, the compressive stress on the concave surface is greater after cold-bending than before cold-bending.

### Other Features

In one or more embodiments, the optical system may include additional materials in the form of layers disposed on the anti-reflection layer or is disposed between the anti-reflection layer and substrate. In one or more embodiments, such additional layers may include adhesion promotors (in the case the additional layer(s) are disposed between the anti-reflection layer and substrate), an easy-to-clean layer, a scratch resistant layer, a decorative layer, etc. In some embodiments, such additional layers may be inorganic materials or organic materials. In some embodiments, the additional layer may be a separate film that is disposed on the anti-reflection layer or between the anti-reflection layer and substrate.

A second aspect of this disclosure pertains to a head-mounted device that is a wearable and includes an optical system described herein. In one or more embodiments, the wearable includes an embodiment of an optical system described herein, and a wearable attachment coupled to the optical system. In some embodiments, the wearable attachment may be arms to mount the optical device to a user's face, to be used similarly to eyeglasses. In some embodiments, the wearable attachment may be a strap or other attachment device.

In one or more embodiments, the optical system may be part of a vehicle (e.g., automobiles, trucks, trains, seacraft, aircraft, etc.). In such embodiments, the optical system may be part of a window (e.g., windshield, side windows, back window, or roof). In some embodiments, the optical system may be a discrete component that is positioned within the interior of the vehicle.

In one or more embodiments, the substrate may include a shape that modifies a user's natural vision or appearance of an external environment.

### EXAMPLES

### Example 1

The following anti-reflective layers were disposed onto a glass-based substrate.

Exemplary Anti-Reflection Layer having 7 sub-layers

| Sublayer material | Thickness (nm) |
|---|---|
| SiO2 | 30.465 |
| Ta2O5 | 28.796 |
| SiO2 | 60.232 |
| Ta2O5 | 40.103 |
| SiO2 | 20.166 |
| Ta2O5 | 69.774 |
| SiO2 | 99.538 |
| Total thickness | 349.074 |

Exemplary Anti-Reflection Layer having 13 sub-layers

| Sublayer material | Thickness (nm) |
|---|---|
| SiO2 | 29.98 |
| Ta2O5 | 20.86 |
| SiO2 | 86.71 |
| Ta2O5 | 20.17 |
| SiO2 | 37.66 |
| Ta2O5 | 81.44 |
| SiO2 | 28.45 |
| Ta2O5 | 22.72 |
| SiO2 | 96.73 |
| Ta2O5 | 26.64 |
| SiO2 | 23.10 |
| Ta2O5 | 68.56 |
| SiO2 | 91.40 |
| Total thickness | 634.42 |

### Example 2

In a prophetic example, the Ta₂O₅ sublayer material is replaced with HfO₂.

### Example 3

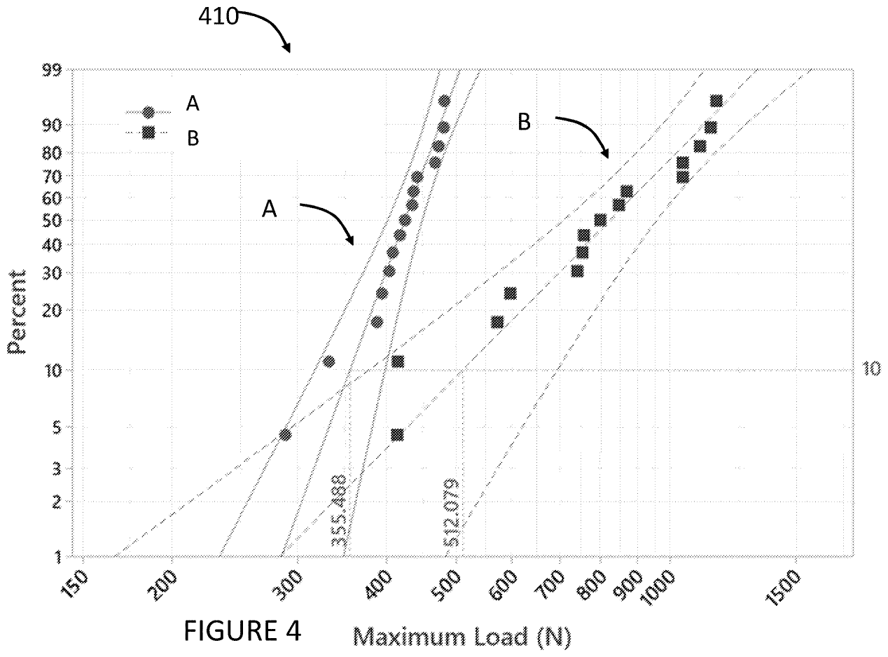

FIG. 4 shows a plot 410 presents probability in percentage of maximum load (i.e. x-axis; aka load at failure), in terms of newtons, for a ring-on-ring test as indicated above (see ASTM C1499). Notably, a 30 mm diameter support ring and a 15 mm diameter loading ring were used to fracture circular samples of glass-based substrates without any layers or coatings (including without any anti-reflection layers) (Samples A) and samples of glass-based substrates identical to those used in Samples A, with an anti-reflection layer (Samples B) on a major surface of the glass-based substrate. The maximum load in the plot 410 is the load at which the rings were pressed together when the samples (A and B) therebetween failed.

The plot 410 is more specifically a Weibull plot corresponding to a 95% confidence interval. Glass-based substrates used in the data of FIG. 4 (for both Samples A and Samples B) were 300 mm in diameter and 0.6 mm in thickness, had a modulus of elasticity of 116 GPa (for at least a portion of their stress-strain response), and the anti-reflection layer in Samples B had a modulus of 80 GPa and thickness of about 2/3 μm in total. The glass-based substrates were brittle and had a high reflective index (specifically in terms of oxide constituents, 33 mol % B₂O₃, 20 mol % La₂O₃, 15 mol % Nb₂O₅, 9 mol % TiO₂, 7 mol % ZrO₂, and 16 mol % WO₃) and the anti-reflection layer used in Samples B had 13 sublayers of Ta₂O₅ and SiO₂ as shown in Example 1, which were applied by evaporative coating process.

Load (x-axis) in FIG. 4 correlates to stress in the glass-based substrate being tested. A finite element model is used to convert load to stress to present a more accurate representation of ring-on-ring behavior than simply using beam theory to convert load to stress. For this test setup, using finite element analysis, the estimated stress in the glass-based substrate (bare, without the anti-reflection layer) in megapascals (MPa) is the following complex polynomial function of applied load in kilograms force (kgf) between the rings:

y=−5.9695E-07x\hat{ }4+3.1132E-04x\hat{ }3-6.2971E-02x\hat{ }2+1.0904E+01x+7.4458E-01, where “y” is stress and “x” is force, where “E” means ‘times 10 to the exponent power of the number following the E,’ and where hat symbol (“\hat{ }”) means ‘to the exponent power of the number following the hat symbol.’ As shown in FIG. 4, Samples B withstood higher loads (N) before failing than Samples A.

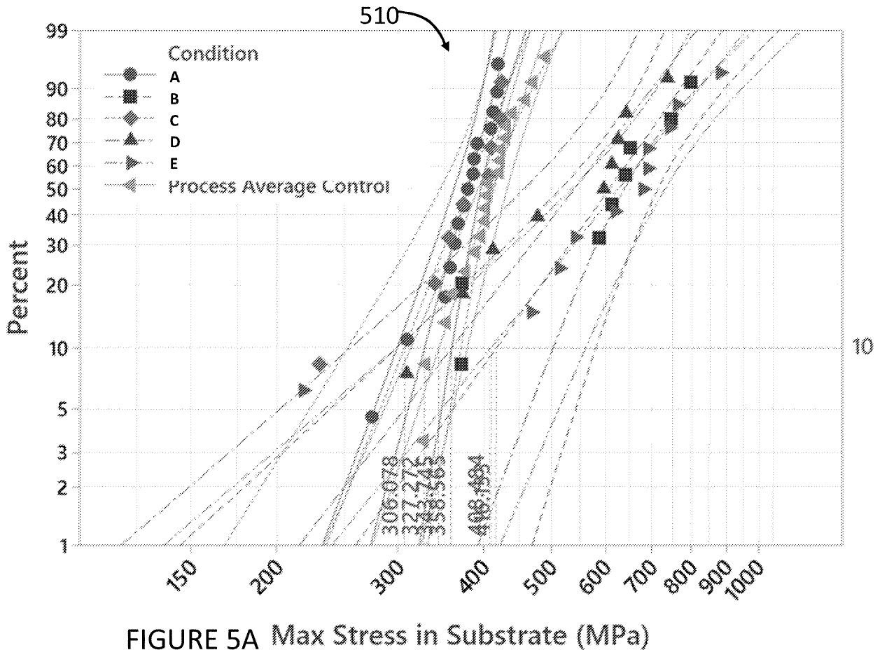

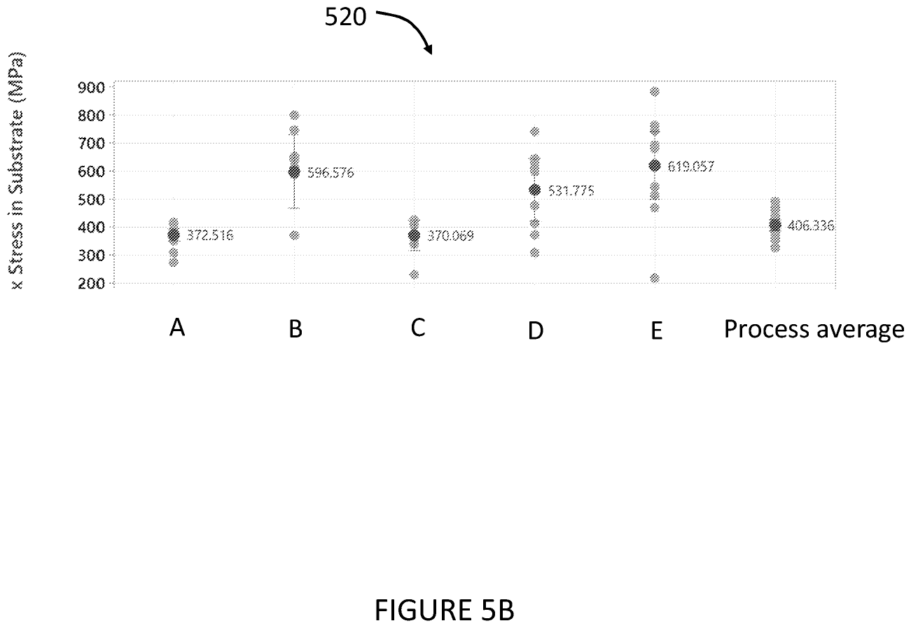

Referring now to FIG. 5A, several glass-based substrates and anti-reflection layers were tested, showing similar strengthening behavior as discussed above with respect to FIG. 4, but with the load converted to Max Stress (aka stress at failure, ultimate stress) in the glass-based substrate (with and without an anti-reflection layer) using the above described finite element model. Similar to FIG. 4, plot 510 of FIG. 5 is a Weibull plot of 95% confidence interval with respect to ring-on-ring tests with the same size samples. Samples A and B are identical to those used FIG. 4. Samples C were identical to Samples A. Samples D included the same glass-based substrates as Samples C and included an anti-reflection layer with 7 sublayers of Ta₂O₅ and SiO₂ as shown in Example 1, applied via sputtering. Samples E included the same glass substrates as Samples A but with an anti-reflection layer with two sublayers of Nb₂O₅ and SiO₂. All anti-reflection layers used in FIG. 5A were less than 1 micron in total thickness, and very thin relative to 0.6 mm thick glass-based samples.

The results of the tests showed the same significant strength improvement exhibited by the optical systems including a glass-based substrate and an anti-reflection layer, according to the embodiments described herein. In the plot 510, B10 ultimate strength values for samples C were 306 MPa (rounded to the nearest integer), 327 MPa for samples A, 344 MPa for “process average control,” 359 MPa for samples D, 408 MPa for Samples E, and 416 MPa for Samples B. Process average control was average from other tests using the same type of glass, but with better surface quality. Notably, the increase in B10 maximum strength (or ultimate strength) exhibited by Samples D and E, as per the ring-on-ring tests, was at least 20 MPa, at least 30 MPa, at least 40 MPa, at least 50 MPa; and for Samples B was also at least 60 MPa, at least 75 MPa, and/or no more than 10 GPa, such as no more than 5 GPa.

In the plot 520 of FIG. 5B, data of plot 510 is reorganized to show “Max Stress” or ultimate stress for each condition, with average ultimate stress specifically enumerated in the plot for each condition. Average ultimate strength values for Sample A were 370 MPa (rounded to the nearest integer), for Sample C were 373 MPa, and for “process average control” were 406 MPa, for Sample D were 532 MPa, for Sample E were 619 MPa, and for Sample B were 597 MPa. Notably, the increase in average maximum strength (or ultimate strength) exhibited by Samples D and E, as per the ring-on-ring tests, was at least 20 MPa, at least 50 MPa, at least 100 MPa, at least 150 MPa; and for Samples B was also at least 200 MPa, at least 220 MPa, and/or no more than 10 GPa, such as no more than 5 GPa. Other strength changes are contemplated. Note “ultimate strength” or “average ultimate strength” means the average maximum strength from ring-on-ring testing as disclosed herein, from a statistically significant population, as specified herein, unless otherwise specified (e.g., B10 ultimate strength).

Surprisingly the anti-reflection layer thickness may not have been controlling in achieving the strength increases observed, as demonstrated with respect to the tests shown in FIGS. 5A-5B. While the fewer sub-layers of Sample D had a less average maximum strength than Sample B (532 MPa versus 597 MPa), Sample E had the highest average maximum strength (619 MPa). Without being bound by theory, the increase in strength may be due to an ability of the anti-reflection layer to hold together and stay laminated to the glass-based substrate, which constrained and insulated crack-initiation sites on a major surface thereof, while the glass-based substrate was loaded to failure.

Aspect (1) of this disclosure pertains to an optical system comprising a substrate comprising first and second opposing major surfaces, a length dimension, a width dimension and a modulus of elasticity; an optical region having an optical region dimension that is less than at least one of or both the length dimension and the width dimension; and an anti-reflection layer disposed on at least the entirety of the optical region dimension, and up to 100% of one or both of the first major surface and the second major surface; wherein the anti-reflection layer comprises a modulus of elasticity that is less than 1.1 times the modulus of elasticity of the substrate, wherein the optical region dimension is in a range from about 30 mm to about 65 mm over a FOV up to 80 degrees, and wherein, when measured at the anti-reflection layer, the substrate and anti-reflection layer comprises a glass-side anti-reflection layer mediated total internal reflection (TIR) reflectance of at least 98%, or an air-side reflectance at an incidence angle up to ±60 degrees of less than 5%, in the visible spectrum from about 450 nm to 650 nm.

Aspect (2) of this disclosure pertains to the optical system of Aspect (1), wherein the substrate comprises a glass-based substrate.

Aspect (3) of this disclosure pertains to the optical system of Aspect (2), wherein the substrate comprises a glass crack onset strain, and the anti-reflection layer comprises a layer crack onset strain that is greater than the glass crack onset strain.

Aspect (4) of this disclosure pertains to the optical system of any one of Aspects (1) through (3), further comprising an input coupler; and an output coupler.

Aspect (5) of this disclosure pertains to the optical system of any one of Aspects (1) through (4), wherein the substrate comprises a thickness of 2 mm or less.

Aspect (6) of this disclosure pertains to the optical system of any one of Aspects (1) through (5), wherein one or both of the first major surface and the second major surface comprises a first radius of curvature of less than 100 mm.

Aspect (7) of this disclosure pertains to the optical system of Aspect (6), wherein the first radius of curvature differs from a second radius of curvature on the opposite major surface.

Aspect (8) of this disclosure pertains to the optical system of Aspect (6) or Aspect (7), wherein the substrate is cold-formed.

Aspect (9) of this disclosure pertains to the optical system of any one of Aspects (1) through (8), further comprising one or more diffraction gratings on one or both of the first major surface and the second major surface.

Aspect (10) of this disclosure pertains to the optical system of any one of Aspects (1) through (9), wherein the glass-based substrate comprises a refractive index of at least 1.5 at a wavelength of 589 nm.

Aspect (11) of this disclosure pertains to a wearable consumer electronics device comprising the optical system of any one of Aspects (1) through (10), and a wearable attachment coupled to the optical system.

Aspect (12) of this disclosure pertains to an optical system comprising: a lightguide comprising first and second opposing major surfaces, a length dimension, a width dimension, a thickness in a range from about 0.1 mm to 1 mm, a density in a range from about 3.5 g/cm³ to about 6 g/cm³, and a modulus of elasticity; an optical region dimension that is less than at least one of or both the length dimension and the width dimension; and an anti-reflection layer disposed on at least the entirety of the optical region dimension and up to 100% of one or both of the first major surface and the second major surface; wherein the anti-reflection layer comprises a modulus of elasticity that is less than 1.1 times the modulus of elasticity of the lightguide, and further comprising a first region configured to receive light from an input coupler, a second region configured to transmit light through an output coupler, and an optical path between the first region and the second region, and one or both of an anti-reflection layer mediated total internal reflection (TIR) transmittance of at least 75% through the optical region along the optical path; and a single-sided reflectance of less than 2%, when measured at the anti-reflection layer at an incidence angle up to ±60 degrees, in the visible spectrum from about 450 nm to 650 nm.

Aspect (13) of this disclosure pertains to the optical system of Aspect (12), wherein the lightguide comprises a glass-based lightguide.

Aspect (14) of this disclosure pertains to the optical system of Aspect (13), wherein the lightguide comprises a glass crack onset strain, and the anti-reflection layer comprises a layer crack onset strain that is greater than the lightguide crack onset strain.

Aspect (15) of this disclosure pertains to the optical system of any one of Aspects (12) through (14), further comprising an input coupler; and an output coupler.

Aspect (16) of this disclosure pertains to the optical system of any one of Aspects (12) through (15), wherein the lightguide comprises a thickness of 5 mm or less.

Aspect (17) of this disclosure pertains to the optical system of any one of Aspects (12) through (16), wherein the optical region dimension is in a range from about 15 mm to about 65 mm.

Aspect (18) of this disclosure pertains to the optical system of any one of Aspects (12) through (17), wherein the substrate comprises a weight in a range from about 1 g to about 150 g.

Aspect (19) of this disclosure pertains to the optical system of any one of Aspects (12) through (18), wherein one or both of the first major surface and the second major surface comprises a first radius of curvature of less than 100 mm.

Aspect (20) of this disclosure pertains to the optical system of Aspect (19), wherein the first radius of curvature differs from a second radius of curvature on the opposing major surface.

Aspect (21) of this disclosure pertains to the optical system of Aspect (19) or Aspect (20), wherein the lightguide is cold-formed.

Aspect (22) of this disclosure pertains to the optical system of any one of Aspects (12) through (21), further comprising one or more diffraction gratings on one or both of the first major surface and the second major surface.

Aspect (23) of this disclosure pertains to the optical system of any one of Aspects (12) through (22), wherein the lightguide comprises a refractive index of at least 1.5 at a wavelength of 589 nm.

Aspect (24) pertains to a wearable consumer electronics device comprising the optical system of any one of Aspects (12) through (24), and a wearable attachment coupled to the optical system.

It will be apparent to those skilled in the art that various modifications and variations can be made without departing from the spirit or scope of the invention.

1. An optical system comprising:
a substrate comprising first and second opposing major surfaces, a length dimension, a width dimension and a modulus of elasticity;
an optical region having an optical region dimension that is less than at least one of or both the length dimension and the width dimension; and
an anti-reflection layer disposed on at least the entirety of the optical region dimension, and up to 100% of one or both of the first major surface and the second major surface;
wherein the anti-reflection layer comprises a modulus of elasticity that is less than 1.1 times the modulus of elasticity of the substrate,
wherein the optical region dimension is in a range from about 30 mm to about 65 mm over a FOV up to 80 degrees, and
wherein, when measured at the anti-reflection layer, the substrate and anti-reflection layer comprises a glass-side anti-reflection layer mediated total internal reflection (TIR) reflectance of at least 98%, or an air-side reflectance at an incidence angle up to ±60 degrees of less than 5%, in the visible spectrum from about 450 nm to 650 nm.

2. The optical system of claim 1, wherein the substrate comprises a glass-based substrate.

3. The optical system of claim 2, wherein the substrate comprises a glass crack onset strain, and the anti-reflection layer comprises a layer crack onset strain that is greater than the glass crack onset strain.

4. The optical system of claim 1, further comprising an input coupler; and an output coupler.

5. The optical system of claim 1, wherein the substrate comprises a thickness of 2 mm or less.

6. The optical system of claim 1, wherein one or both of the first major surface and the second major surface comprises a first radius of curvature of less than 100 mm.

7. The optical system of claim 6, wherein the first radius of curvature differs from a second radius of curvature on the opposite major surface.

8. The optical system of claim 6, wherein the substrate is cold-formed.

9. The optical system of claim 1, further comprising one or more diffraction gratings on one or both of the first major surface and the second major surface.

10. The optical system of claim 1, wherein the glass-based substrate comprises a refractive index of at least 1.5 at a wavelength of 589 nm.

11. A wearable consumer electronics device comprising the optical system of claim 1, and a wearable attachment coupled to the optical system.

12. An optical system comprising:
a lightguide comprising first and second opposing major surfaces, a length dimension, a width dimension, a thickness in a range from about 0.1 mm to 1 mm, a density in a range from about 3.5 g/cm³ to about 6 g/cm³, and a modulus of elasticity;
an optical region dimension that is less than at least one of or both the length dimension and the width dimension; and
an anti-reflection layer disposed on at least the entirety of the optical region dimension and up to 100% of one or both of the first major surface and the second major surface;
wherein the anti-reflection layer comprises a modulus of elasticity that is less than 1.1 times the modulus of elasticity of the lightguide, and
further comprising a first region configured to receive light from an input coupler, a second region configured to transmit light through an output coupler, and an optical path between the first region and the second region, and
one or both of
an anti-reflection layer mediated total internal reflection (TIR) transmittance of at least 75% through the optical region along the optical path; and
a single-sided reflectance of less than 2%, when measured at the anti-reflection layer at an incidence angle up to ±60 degrees, in the visible spectrum from about 450 nm to 650 nm.

13. The optical system of claim 12, wherein the lightguide comprises a glass-based lightguide.

14. The optical system of claim 13, wherein the lightguide comprises a glass crack onset strain, and the anti-reflection layer comprises a layer crack onset strain that is greater than the lightguide crack onset strain.

15. The optical system of claim 12, further comprising an input coupler; and an output coupler.

16. The optical system of claim 12, wherein the lightguide comprises a thickness of 5 mm or less.

17. The optical system of claim 12, wherein the optical region dimension is in a range from about 15 mm to about 65 mm.

18. The optical system of claim 12, wherein the substrate comprises a weight in a range from about 1 g to about 150 g.

19. The optical system of claim 12, wherein one or both of the first major surface and the second major surface comprises a first radius of curvature of less than 100 mm.

20. The optical system of claim 19, wherein the first radius of curvature differs from a second radius of curvature on the opposing major surface.

21.-24. (canceled)
